(19) United States
(12) Patent Application Publication
(10) Pub. No.: US 2026/0203411 A1
(43) Pub. Date: Jul. 16, 2026

(54) GENERATIVE ARTIFICIAL INTELLIGENCE BASED INTERACTION RISK ASSESSMENT

(71) Applicant: International Business Machines Corporation, Armonk, NY (US)

(72) Inventors: Colton Williams, Leander, TX (US); Milan Saumil Patel, Raleigh, NC (US); Sridhar Muppidi, Austin, TX (US)

(21) Appl. No.: 19/020,895

(22) Filed: Jan. 14, 2025

(51) Int. Cl. G06F 21/57

(52) U.S. Cl. CPC G06F 21/577; G06F 2221/034

(57) ABSTRACT

Mechanisms are provided that detect, by a decentralized identity event agent executing in a first computing system of a decentralized identity framework, an identity based interaction between the first computing system and a second computing system of the decentralized identity framework. The mechanisms automatically generate, by the decentralized identity event agent, a dynamic retrieval augmented generation (RAG) prompt comprising context information incorporating data corresponding to the interaction. The mechanisms provide the dynamic RAG prompt to a language computer model for processing to generate a risk assessment output. The mechanisms apply one or more policies to the detected identity based interaction based on the risk assessment output to accept or reject performance of the identity based interaction between the first computing system and the second computing system.

### BACKGROUND

The present application relates generally to a data processing apparatus and method and more specifically to a computing tool and computing tool operations/functionality for generative artificial intelligence based interaction risk assessment.

Identities in computing systems are digital identifications of entities used to verify those entities when performing operations within the computing system. The use of identities, e.g., private keys, public keys, digital certificates, usernames/passwords, and the like, for identifying and verifying an entity has evolved over the last twenty-five years. This evolution or shift has progressed towards identities being controlled by the individual or entity to which the identity pertains.

That is, initially a centralized digital identity system solution was (and in many cases still is) used where the identity associated with an individual or entity was provided by, and affiliated with, a single organization and could only be used within the relationship between the individual/entity and that organization. Examples of this type of centralized identity management based solution include HyperText Transfer Protocol Secure (HTTPS) based systems, Secure Socket Layer (SSL) based systems, and Transport Layer Security (TLS) protocol based systems.

This solution evolved into federated digital identity systems where an identity could be used across a plurality of organizations that cooperate with each other and have trust rooted. In federated digital identity systems, verification is dependent on a single identity provider. Examples of federated digital identity system solutions include Security Assertion Markup Language (SAML) based systems, OpenID Connect protocol based systems, and Open Authorization (OAuth) based systems.

More recently, this digital identity systems have further evolved into what is known as digital credential based computing systems. With digital credential based computing systems, users own, store, and present attested data through point-to-point interactions where trust is rooted in a decentralized system or ledger. Examples of digital credential based digital identity systems include Decentralized Identifiers (DIDs) based systems, Verifiable Credentials, and Distributed Key Management Systems (DKMS).

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method is provided that comprises detecting, by a decentralized identity event agent executing in a first computing system of a decentralized identity framework, an identity based interaction between the first computing system and a second computing system of the decentralized identity framework. The method further comprises automatically generating, by the decentralized identity event agent, a dynamic retrieval augmented generation (RAG) prompt comprising context information incorporating data corresponding to the interaction. In addition, the method comprises providing the dynamic RAG prompt to a language computer model for processing to generate a risk assessment output. Furthermore, the method comprises applying one or more policies to the detected identity based interaction based on the risk assessment output to accept or reject performance of the identity based interaction between the first computing system and the second computing system.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a decentralized identity interaction in accordance with one illustrative embodiment;

FIG. 2 is an example diagram of a distributed data processing system environment in which aspects of the illustrative embodiments may be implemented and at least some of the computer code involved in performing the inventive methods may be executed;

FIG. 3 is an example block diagram of the primary operational components of a GenAI based interaction risk assessor for decentralized identity interactions in accordance with one illustrative embodiment;

FIG. 4 is an example flowchart of a GenAI based interaction risk assessment operation in accordance with one illustrative embodiment.

### DETAILED DESCRIPTION

The illustrative embodiments provide an improved computing tool and improved computing tool operations/functionality for generative artificial intelligence based interaction risk assessment. The illustrative embodiments provide computer mechanisms that improve the operation of decentralized identity interactions by providing an ability for verifiers, holders, and issuers of identities/credentials to obtain intelligent assessments of the risks of interactions using such identities/credentials based on evidence of potential or actual compromises of these identities/credentials.

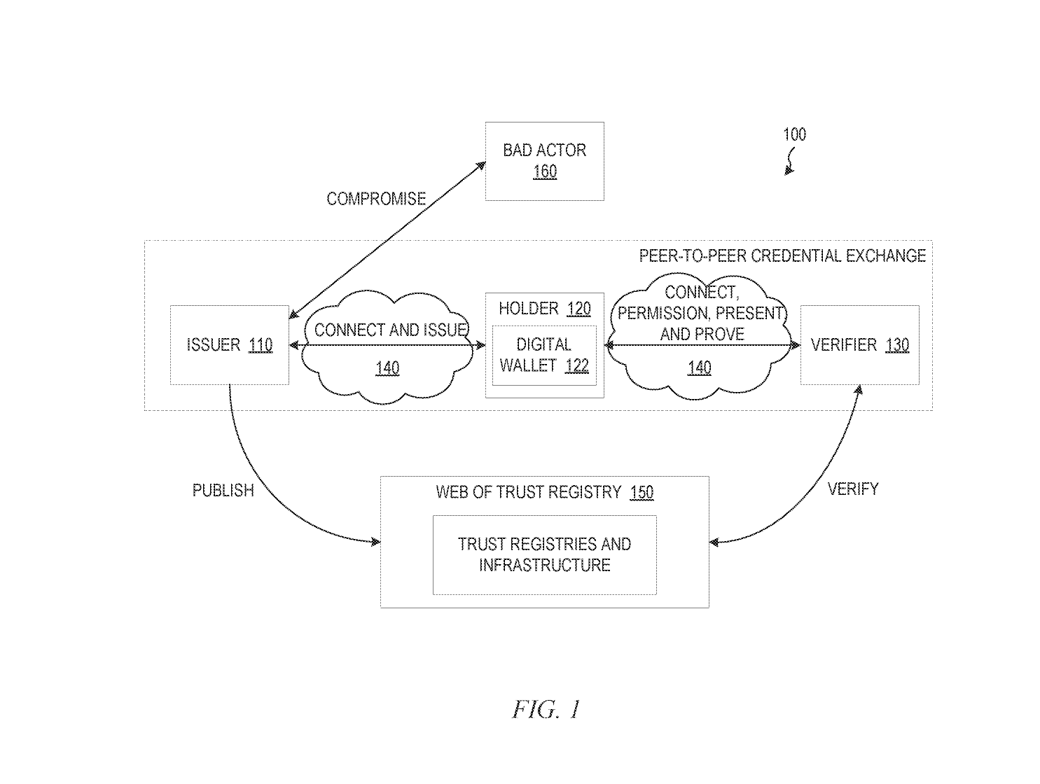

FIG. 1 is an example diagram of a decentralized identity interaction in accordance with one illustrative embodiment. As shown in FIG. 1, the decentralized identity framework or ecosystem 100 comprises an issuer computing system (issuer) 110, a holder computing system (holder) 120, and a verifier computing system (verifier) 130. In this framework 100, the holder 120 registers with an issuer 110 and receives from the issuer 110 a decentralized identifier (DID) and cryptographic keys, e.g., private/public key pair. The issuer 110 obtains the verified credentials (digital certificates) issued by trusted entities, e.g., governmental, education, or other organizations, which provide an affirmation of the holder’s personal information or identity information. The verified credentials are signed by the issuer and associated with the public key of the holder 120, ensuring the authenticity of the credentials and that the holder 120 is the authorized owner of those credentials. These signed and verified credentials may be considered the decentralized identity of the holder 120 and may be stored in a digital wallet 122 or other identity container of the holder computing system 120.

The holder computing system 120 may be any type of computing device, such as a mobile smartphone device, a laptop or desktop computer, tablet computer, or the like, that may operate as a holder of issued digital credentials. The issuer 110 and verifier 130 may likewise be various types of computing devices, such as systems comprising one or more server computing devices, network attached storage devices, and the like. The holder 120 may communicate via digital transmissions of data with the issuer 110 and verifier 130 via one or more wired/wireless data networks 140.

The holder 120 connects with the issuer 110 to obtain the issuance of credentials that verify the personal information and identity details of that holder 120 that are shared with the issuer 110. The issuer 110 may publish interactions of issuing the credentials to a Web of Trust registry 150 having trust registries and corresponding infrastructure, such as a distributed ledger technology (DLT), or blockchain based registry storing immutable records of interactions, for example. The holder 120 connects with the verifier 130 to request access to computing resources associated with the verifier 130 by requesting permission to perform an operation, presenting the holder’s credentials, and proving their identity to the verifier 130. The verifier 130 verifies the credentials presented by the holder 120 against the public information stored in the Web of Trust registry 150 and either permits or rejects the holder’s request based on the results of the verification.

The decentralized identity framework 100 provides the ability for the holder 120 to verify their identity and control the sharing of their personal information via their signed and verified credentials. That is, the holder 120 is the one that determines which credentials to present and the amount of the personal information that is accessed via those credentials. Thus, the decentralized identity framework 100 provides individuals the ability to manage their own identities, regardless of who the issuer 110 may be. The decentralized identity framework 100 is a user-centric method of managing digital identities without relying on centralized authorities. By using a DLT, e.g., blockchain, self-sovereign identity wallets, and/or other decentralized technologies, decentralized identity frameworks, such as that shown in FIG. 1, reduce the risk of data breaches since sensitive information is not concentrated in a centralized database, such as in centralized identity systems. Moreover, decentralized identity frameworks provide interoperability across various platforms and services thereby eliminating requirements for users to perform multiple login operations.

Verifiable credential and decentralized identity interactions rely on the distributed networks to verify the identity and permission of the holder 120 based on their presented credentials and the trustworthiness of the originating issuer 110 of that credential. However, if an issuer 110 is compromised and issues credentials to a bad (i.e., threat) actor 160, and it is determined that such a compromise has occurred, it is difficult to know who is a valid user and who is a threat actor when the issuer 110 was compromised, i.e., the verifier 130 cannot distinguish between a valid holder 120 and the bad actor 160 when the credentials issued to each are within a given window of time of the compromise occurring. Put another way, once the issuer 110 is labeled as having been compromised and thus, not trusted, other participants, e.g., verifier 130, in the credential exchange network of the decentralized identity framework 100 will not inherently know whether a holder 120 presenting credentials issued by the compromised issuer is valid or a threat actor. Without knowing the nature of the holder 120, one cannot send alerts to participants in the credential exchange network to inform them that the holder 120 is safe or risky to validate based on the issuer 110 having been compromised. Similarly, a holder 120 is not made aware if they are presenting credentials issued to them from an issuer 110 that has been compromised.

The illustrative embodiments provide a computing tool and computing tool operations/functionality that comprises a fine-tuned Large Language Model (LLM) that is populated with data from interactions of a verifier 130 or a digital wallet/identity “container” of a holder 120, and which operates to assign a risk score to verifiable credentials presented by holders (users) 120, issued by issuers 110, and received by verifiers 130. The fine-tuned LLM of the illustrative embodiments may be part of, or utilized by, a Generative Artificial Intelligence (GenAI) system to identify the risky interactions in the credential exchange network of a decentralized identity framework 100. For those interactions determined to be risky, such as due to a compromise in an entity of the credential exchange network, e.g., issuer 110, holder 120, or verifier 130, remediation operations are implemented (e.g., access policies) to perform appropriate remediation actions and/or notify the necessary party or parties that the interaction is potentially risky and to proceed with caution.

For an end user (holder) computing device, e.g., holder 120, when the end user is using their digital wallet or identity “container” of their computing device 120 to prove their identity, the digital wallet or identity container performs operations via the mechanisms of the illustrative embodiments to assess the risk of the verifier 130 with which the end user is interacting. Based on the assessment, if the mechanisms of the illustrative embodiments determine that the verifier 130 is risky, the digital wallet/identity container may output an alert to the end user (holder) via their computing device 120 that the verifier 130 is potentially risky. The end user (holder) computing device 120 may provide a dashboard associated with the digital wallet/identity container that provides a graphical user interface (GUI) or other visual/audible output to provide information specifying which verifiers and issuers have been determined to be risky.

For a verifier computing system 130, when the verifier 130 is receiving an identity credential from a holder computing device 120, the verifier 130 may utilize the mechanisms of the illustrative embodiments to perform a risk assessment with regard to the issuer 110 of the credential presented by the holder 120. The verifier computing system 130 may have a dashboard that can track the number of risky interactions and report on these risky interactions to system administrators, holders 120 involved in the interactions, authorized personnel associated with the issuer 110, or the like. The verifier computing system 130 may also use an access policy based on the assessed risk score to determine the outcome of the interaction, e.g., accept/reject the holder’s identity credentials based on a determined level of risk.

Whether for the holder computing system 120 or the verifier computing system 130, the GenAI based risk assessment mechanisms of the illustrative embodiments may consume the data associated with digital interactions as well as their risk score assessments to perform continual fine-tuned training of the GenAI computer models of the GenAI based risk assessment mechanisms so as to identify risk of interactions more quickly and accurately. The GenAI based risk assessment mechanisms operate in conjunction with these fine-tuned GenAI computer models, such as a fine-tuned language model (LM) or large language model (LLM), which have access to the data from interactions of the verifier 130, the holder 120, and/or the issuer 110, as well as third party sources of information providing indicators of compromise, e.g., source computing systems providing natural language content describing compromises to entities of decentralized identity frameworks, e.g., cybersecurity related blogs, social media websites, sources of cybersecurity data, and the like. These third party sources of information provide this data which is collectively referred to as public indicators of compromise (IoC) and risk feeds.

Thus, the illustrative embodiments provide a computing tool and computing tool operations/functionality that leverages the power of foundational computer models, such as LMs/LLMs, and GenAI to generatively learn and proactively recommend risk levels for interactions with holders and/or verifiers in a decentralized identity framework or credential ecosystem. A GenAI risk assessor is provided that correlates credential and connection events across N number of holders, issuers, and verifiers participating in the decentralized credential ecosystem. The foundational computer model is fine-tuned and prompted to associate a risk score for each credential flow based on learnings and generative AI analysis of large-scale ecosystem events, e.g., compromises of issuers, verifiers, or the like. The illustrative embodiments provide mechanisms that may augment existing indicators of compromise with real time activity associated with credential events.

The following description provides examples of embodiments of the present disclosure, and variations and substitutions may be made in other embodiments. Several examples will now be provided to further clarify various aspects of the present disclosure.

Example 1: A method comprising detecting, by a decentralized identity event agent executing in a first computing system of a decentralized identity framework, an identity based interaction between the first computing system and a second computing system of the decentralized identity framework. The method further comprises automatically generating, by the decentralized identity event agent, a dynamic retrieval augmented generation (RAG) prompt comprising context information incorporating data corresponding to the interaction. Moreover, the method comprises providing the dynamic RAG prompt to a language computer model for processing to generate a risk assessment output, and applying one or more policies to the detected identity based interaction based on the risk assessment output to accept or reject performance of the identity based interaction between the first computing system and the second computing system. The above limitations advantageously enable the leveraging of language computer models and retrieval augmented generation prompts to obtain a risk assessment regarding identities involved in an identity based interaction. The above limitations advantageously enable application of policies for mitigating or minimizing the risk to entities involved in identity based interactions based on an assessment of risk along a spectrum of risk assessments.

Example 2: The limitations of any of Examples 1 and 3-11, where the method further comprises generating a risk score based on the risk assessment output from the language computer model, wherein the one or more policies are applied to the detected identity based on the risk score. The above limitations advantageously enable a quantification of the risk of identities or credentials involved in an identity based interaction in a decentralized identity framework such that policies may be applied based on the quantitative assessment of risk. This allows a more controlled application of policies.

Example 3: The limitations of any of Examples 1-2 and 4-11, where the language computer model is a pre-trained large language model (LLM) that is fine-tune trained to specifically perform risk assessments of identities based on input features from interactions of one or more verifier computing systems or digital identity containers of identity holder computing systems. The above limitations advantageously enable the leveraging of the pre-training of LLMs as a basis for the evaluation of risks in performing interactions with entities based on their identities or credentials. The above limitations advantageously enable the fine-tuning of a pre-trained LLM for the specific purpose of operating to perform risk assessments of identities involved in identity based interactions, and specifically with fine-tuning based on input features from specifically interactions of one or more verifier computing systems or digital identity containers of identity holder computing systems.

Example 4: The limitations of any of Examples 1-3 and 5-11, where the language computer model is a pre-trained large language model (LLM) that is fine-tune trained to specifically perform risk assessments of identities based on input features comprising indicators of compromise from third party computing systems. The above limitations advantageously enable the leveraging of the pre-training of LLMs as a basis for the evaluation of risks in performing interactions with entities based on their identities or credentials. The above limitations advantageously enable the fine-tuning of a pre-trained LLM for the specific purpose of operating to perform risk assessments of identities involved in identity based interactions, and specifically with fine-tuning based on input features that are indicators of compromise obtained from third party computing systems. This allows for a relatively larger set of sources of information that can be used to identify patterns indicative of potential compromise of identities (credentials).

Example 5: The limitations of any of claims 1-4 and 6-11, where the third party computing systems comprise one or more of security information and event management (SIEM) computing systems, cybersecurity event logs of third party computing systems, or extended detection and response (XDR) computing systems. The above limitations advantageously enable obtaining indicators of compromise from cybersecurity systems based on their specific operations which indicate compromised identities/credentials.

Example 6: The limitations of any of claims 1-5 and 7-11, where the first computing device is an identity holder computing device and the second computing device is an identity verifier computing device, and wherein the language computer model generates a risk assessment output that evaluates a level of risk of the holder computing device to the verifier computing device. The above limitations advantageously enable verifiers to obtain an indication of the risk in performing interactions with specific identity holders.

Example 7: The limitations of any of claims 1-6 and 8-11, where the first computing device is an identity holder computing device and the second computing device is an identity verifier computing device, and wherein the language computer model generates a risk assessment output evaluates a level of risk of the verifier computing device to the holder computing device. The above limitations advantageously enable identity holders to obtain an indication of the risk in performing interactions with specific verifiers.

Example 8: The limitations of any of claims 1-7 and 9-11, where the method further comprises generating a graphical user interface on the first computing device specifying which verifiers and issuers in the decentralized identity framework have been determined to have a risk assessment indicating they are risky with which to perform interactions. The above limitations enable identity holders, verifiers, and issuers to determine which verifiers and issuers of identities/credentials are potentially compromised and may have elevated risks of interacting with these entities.

Example 9: The limitations of any of claims 1-8 and 10-11, where the context information in the RAG prompt comprises interaction features collected by an identity container of an entity requesting verification of another entity involved in the identity based interaction. The above limitations advantageously enable the automated population of context information in RAG prompts based on information collected by identity containers of the entity requesting the verification of the other entity.

Example 10: The limitations of any of claims 1-9 and 11, where applying one or more policies to the detected identity comprises performing a remediation action to minimize risk to at least one of the first computing system or the second computing system. The above limitations advantageously enable the performance of a remediation action commensurate with the determined level of risk and thereby minimize the risk to the computing systems involved in the identity based interaction.

Example 11: The limitations of any of claims 1-10, where the context information in the RAG prompt comprises private features identifying specific features of the interaction, and public features obtained from a web of trust registry. The above limitations advantageously enable the language models to generate risk assessments based on not only the private information specific to the particular interaction, but also public information available from established web of trust registries, so that a more comprehensive assessment of risk is make possible.

Example 12: A computer program product comprising one or more computer readable storage media, and program instructions collectively stored on the one or more computer readable storage media, the program instructions comprising instructions configured to cause one or more processors to perform a method according to any one of Examples 1 – 11. The above limitations advantageously enable a computer program product having program instructions configured to cause one or more processors to perform and realize the advantages described with respect to Examples 1 – 11.

Example 13: A system comprising one or more processors and one or more computer-readable storage media collectively storing program instructions which, when executed by the one or more processors, are configured to cause the one or more processors to perform a method according to any one of Examples 1 – 11. The above limitations advantageously enable a system comprising one or more processors to perform and realize the advantages described with respect to Examples 1 – 11.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A "mechanism," as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides computer functionality to evaluate the risk of interactions based on identity credentials in decentralized identity interactions. The improved computing tool implements mechanism and functionality, such as a Generative Artificial Intelligence (GenAI) based interaction risk assessor, which cannot be practically performed by human beings either outside of, or with the assistance of, a technical environment, such as a mental process or the like. The improved computing tool provides a practical application of the methodology at least in that the improved computing tool is able to assess the risk of credentials based on a GenAI evaluation of credentials taking into account a variety of sources of information regarding compromises of issuers and verifiers of credentials.

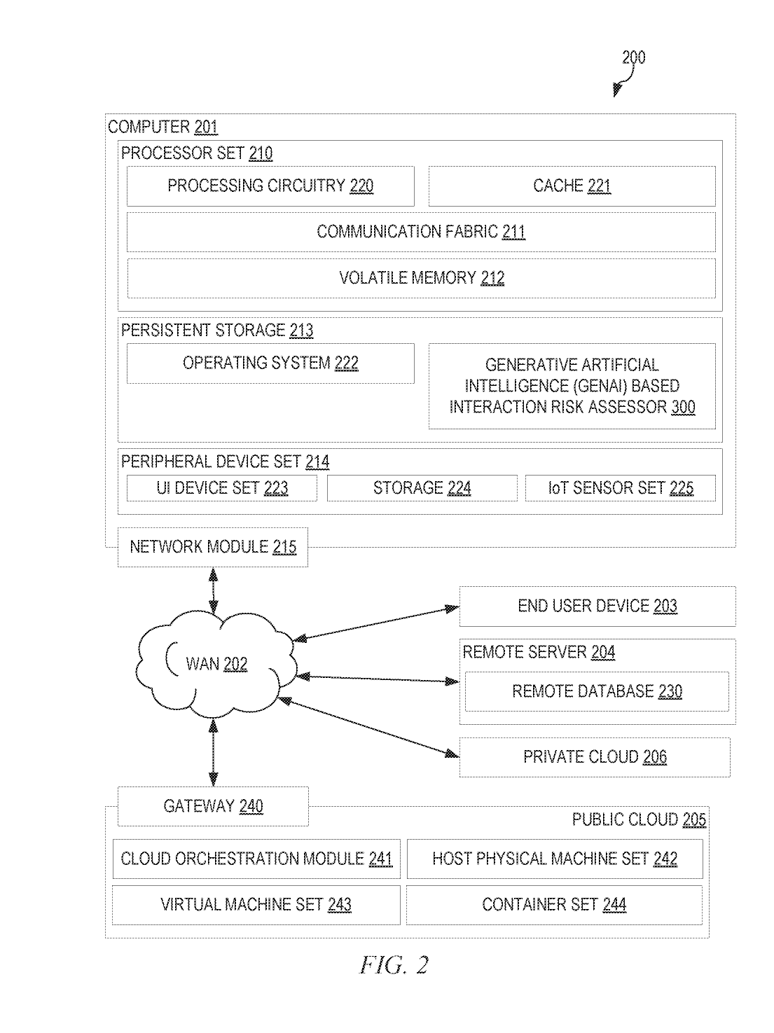

FIG. 2 is an example diagram of a distributed data processing system environment in which aspects of the illustrative embodiments may be implemented and at least some of the computer code involved in performing the inventive methods may be executed. That is, computing environment 200 contains an example of an environment for the execution of at least some of the computer code involved in performing the inventive methods, such as Generative Artificial Intelligence (GenAI) based interaction risk assessor 300 for decentralized identity interactions. In addition to GenAI based interaction risk assessor 300, computing environment 200 includes, for example, computer 201, wide area network (WAN) 202, end user device (EUD) 203, remote server 204, public cloud 205, and private cloud 206. In this embodiment, computer 201 includes processor set 210 (including processing circuitry 220 and cache 221), communication fabric 211, volatile memory 212, persistent storage 213 (including operating system 222 and GenAI based interaction risk assessor 300, as identified above), peripheral device set 214 (including user interface (UI), device set 223, storage 224, and Internet of Things (IoT) sensor set 225), and network module 215. Remote server 204 includes remote database 230. Public cloud 205 includes gateway 240, cloud orchestration module 241, host physical machine set 242, virtual machine set 243, and container set 244.

Computer 201 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 230. As is well understood in the art of computer technology, and depending upon the technology, performance of a computer-implemented method may be distributed among multiple computers and/or between multiple locations. On the other hand, in this presentation of computing environment 200, detailed discussion is focused on a single computer, specifically computer 201, to keep the presentation as simple as possible. Computer 201 may be located in a cloud, even though it is not shown in a cloud in FIG. 2. On the other hand, computer 201 is not required to be in a cloud except to any extent as may be affirmatively indicated.

Processor set 210 includes one, or more, computer processors of any type now known or to be developed in the future. Processing circuitry 220 may be distributed over multiple packages, for example, multiple, coordinated integrated circuit chips. Processing circuitry 220 may implement multiple processor threads and/or multiple processor cores. Cache 221 is memory that is located in the processor chip package(s) and is typically used for data or code that should be available for rapid access by the threads or cores running on processor set 210. Cache memories are typically organized into multiple levels depending upon relative proximity to the processing circuitry. Alternatively, some, or all, of the cache for the processor set may be located “off chip.” In some computing environments, processor set 210 may be designed for working with qubits and performing quantum computing.

Computer readable program instructions are typically loaded onto computer 201 to cause a series of operational steps to be performed by processor set 210 of computer 201 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 221 and the other storage media discussed below. The program instructions, and associated data, are accessed by processor set 210 to control and direct performance of the inventive methods. In computing environment 200, at least some of the instructions for performing the inventive methods may be stored in GenAI based interaction risk assessor 300 in persistent storage 213.

Communication fabric 211 is the signal conduction paths that allow the various components of computer 201 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

Volatile memory 212 is any type of volatile memory now known or to be developed in the future. Examples include dynamic type random access memory (RAM) or static type RAM. Typically, the volatile memory is characterized by random access, but this is not required unless affirmatively indicated. In computer 201, the volatile memory 212 is located in a single package and is internal to computer 201, but, alternatively or additionally, the volatile memory may be distributed over multiple packages and/or located externally with respect to computer 201.

Persistent storage 213 is any form of non-volatile storage for computers that is now known or to be developed in the future. The non-volatility of this storage means that the stored data is maintained regardless of whether power is being supplied to computer 201 and/or directly to persistent storage 213. Persistent storage 213 may be a read only memory (ROM), but typically at least a portion of the persistent storage allows writing of data, deletion of data and re-writing of data. Some familiar forms of persistent storage include magnetic disks and solid state storage devices. Operating system 222 may take several forms, such as various known proprietary operating systems or open source Portable Operating System Interface type operating systems that employ a kernel. The code included in GenAI based interaction risk assessor 300 typically includes at least some of the computer code involved in performing the inventive methods.

Peripheral device set 214 includes the set of peripheral devices of computer 201. Data communication connections between the peripheral devices and the other components of computer 201 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 223 may include components such as a display screen, speaker, microphone, wearable devices (such as goggles and smart watches), keyboard, mouse, printer, touchpad, game controllers, and haptic devices. Storage 224 is external storage, such as an external hard drive, or insertable storage, such as an SD card. Storage 224 may be persistent and/or volatile. In some embodiments, storage 224 may take the form of a quantum computing storage device for storing data in the form of qubits. In embodiments where computer 201 is required to have a large amount of storage (for example, where computer 201 locally stores and manages a large database) then this storage may be provided by peripheral storage devices designed for storing very large amounts of data, such as a storage area network (SAN) that is shared by multiple, geographically distributed computers. IoT sensor set 225 is made up of sensors that can be used in Internet of Things applications. For example, one sensor may be a thermometer and another sensor may be a motion detector.

Network module 215 is the collection of computer software, hardware, and firmware that allows computer 201 to communicate with other computers through WAN 202. Network module 215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 215 are performed on the same physical hardware device. In other embodiments (for example, embodiments that utilize software-defined networking (SDN)), the control functions and the forwarding functions of network module 215 are performed on physically separate devices, such that the control functions manage several different network hardware devices. Computer readable program instructions for performing the inventive methods can typically be downloaded to computer 201 from an external computer or external storage device through a network adapter card or network interface included in network module 215.

WAN 202 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 203 is any computer system that is used and controlled by an end user (for example, a customer of an enterprise that operates computer 201), and may take any of the forms discussed above in connection with computer 201. EUD 203 typically receives helpful and useful data from the operations of computer 201. For example, in a hypothetical case where computer 201 is designed to provide a recommendation to an end user, this recommendation would typically be communicated from network module 215 of computer 201 through WAN 202 to EUD 203. In this way, EUD 203 can display, or otherwise present, the recommendation to an end user. In some embodiments, EUD 203 may be a client device, such as thin client, heavy client, mainframe computer, desktop computer and so on.

Remote server 204 is any computer system that serves at least some data and/or functionality to computer 201. Remote server 204 may be controlled and used by the same entity that operates computer 201. Remote server 204 represents the machine(s) that collect and store helpful and useful data for use by other computers, such as computer 201. For example, in a hypothetical case where computer 201 is designed and programmed to provide a recommendation based on historical data, then this historical data may be provided to computer 201 from remote database 230 of remote server 204.

Public cloud 205 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 205 is performed by the computer hardware and/or software of cloud orchestration module 241. The computing resources provided by public cloud 205 are typically implemented by virtual computing environments that run on various computers making up the computers of host physical machine set 242, which is the universe of physical computers in and/or available to public cloud 205. The virtual computing environments (VCEs) typically take the form of virtual machines from virtual machine set 243 and/or containers from container set 244. It is understood that these VCEs may be stored as images and may be transferred among and between the various physical machine hosts, either as images or after instantiation of the VCE. Cloud orchestration module 241 manages the transfer and storage of images, deploys new instantiations of VCEs and manages active instantiations of VCE deployments. Gateway 240 is the collection of computer software, hardware, and firmware that allows public cloud 205 to communicate through WAN 202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 206 is similar to public cloud 205, except that the computing resources are only available for use by a single enterprise. While private cloud 206 is depicted as being in communication with WAN 202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 205 and private cloud 206 are both part of a larger hybrid cloud.

As shown in FIG. 2, one or more of the computing devices, e.g., computer 201 or remote server 204, may be specifically configured to implement a GenAI based interaction risk assessor 300. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computer 201 or remote server 204, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates risk assessments of holders, issuers, and verifiers in decentralized identity interactions and performing remediation actions and notifications to minimize the ability for bad actors to gain access to protected resources.

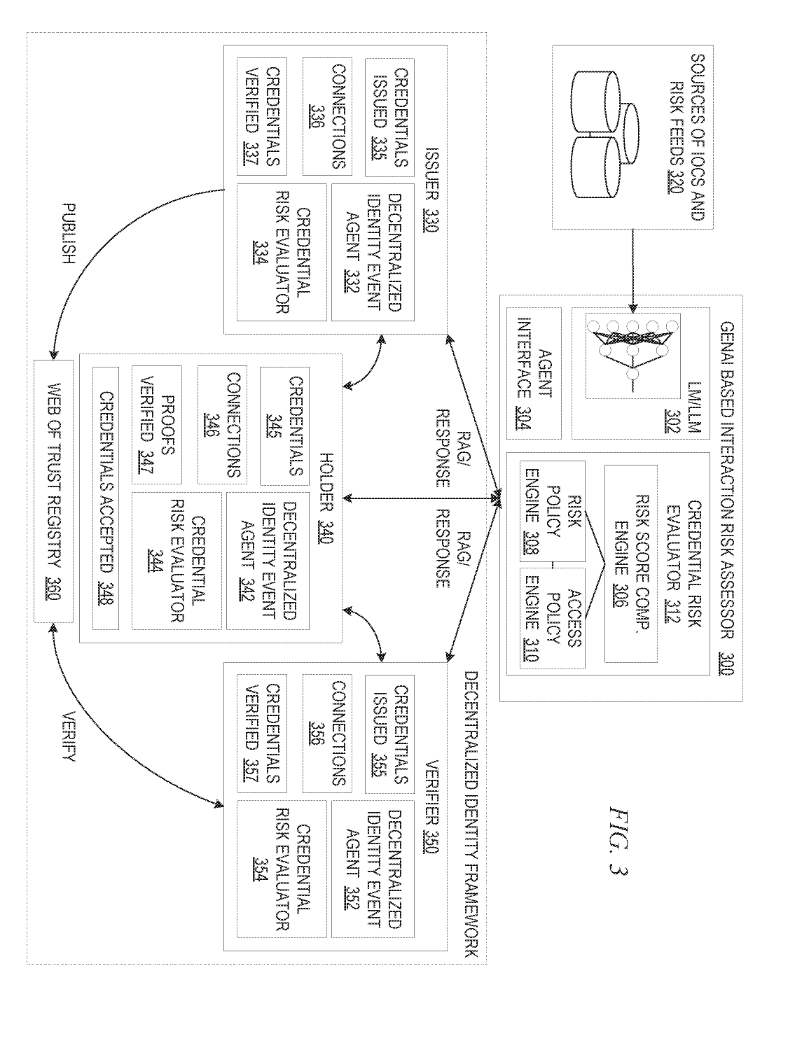

FIG. 3 is an example block diagram of the primary operational components of a Generative Artificial Intelligence (GenAI) based interaction risk assessor for decentralized identity interactions in accordance with one illustrative embodiment. The operational components shown in FIG. 3 may be implemented as dedicated computer hardware components, computer software executing on computer hardware which is then configured to perform the specific computer operations attributed to that component, or any combination of dedicated computer hardware and computer software configured computer hardware. It should be appreciated that these operational components perform the attributed operations automatically, without human intervention, even though inputs may be provided by human beings, e.g., search queries, and the resulting output may aid human beings. The invention is specifically directed to the automatically operating computer components directed to improving the way that decentralized identity interactions are performed in a data network, and providing a specific solution that implements a GenAI based assessment of risk associated with holders, issuers, and/or verifiers in a decentralized identity framework, which cannot be practically performed by human beings as a mental process and is not directed to organizing any human activity.

As shown in FIG. 3, and with reference again to the computer 201 in FIG. 2, in the context of a decentralized identity framework, such as described previously with regard to FIG. 1, the computing system 201 implementing the GenAI based interaction risk assessor 300 may be a third party computing system that operates in conjunction with issuers 110, holders 120, and/or verifiers 130 to assist in assessing and reporting to these entities 110-130 the risk of an interaction between the entity and other entities, e.g., between holders 120 and verifiers 130, based on an assessment of indicators of compromise (IoCs) and risk feeds from a plurality of different public and/or private cybersecurity related sources. The third party computing system may be a cloud service that provides risk assessment for transactions or interactions between entities of a distributed identity framework.

As shown in FIG. 3, the GenAI based interaction risk assessor 300 (hereafter referred to simply as the “risk assessor” 300) comprises a fine-tuned language model (LM) or large language model (LLM) 302, decentralized identity event agent interface 304, risk score computation engine 306, risk policy engine 308, and access policy engine 310. The risk score computation engine 306, risk policy engine 380, and access policy engine 310 may together constitute a credential risk evaluator 312 which operates to evaluate the risk of a credential (identity) offered as part of a transaction and applies appropriate policies based on the determined level of risk. It should be appreciated that these elements of the risk assessor 300 may be implemented in combination with other computing elements, such as operating systems, libraries, data communication interfaces and data network adapters, application programming interfaces (APIs), storage devices, and the like, which provide supportive computing capabilities to support the operations and functionality of the elements 302-312, but which are not shown for simplicity.

The fine-tuned LM/LLM 302 is a generative artificial intelligence (AI) computer model, such as a transformer architecture computer model, that is pre-trained using a large scale general corpus of information and knowledge to generate natural language responses to natural language inputs. An example of a LM/LLM that may be the basis for the fine-tuned LM/LLM 302 may be a Generative Pre-Trained Transformer (GPT) computer model, e.g., any of the “GPT-n” series of AI computer models.

The pre-trained LM/LLM may be fine-tuned based on data from sources of indicators of compromise (IoCs) and risk feeds to specifically generate risk responses assessing the level of risk of a given transaction or interaction between entities, e.g., issuer, holder, and verifier, of decentralized identity frameworks. The IoCs are information about security breaches and cyber-attacks that have taken place and may specify various details of the attack, e.g., attack vector, type of malware used, addresses involved in the attack, and the like, which can then be used to assist with hardening defenses against such security breaches and attacks. These IoCs may include network-based IoCs such as malicious IP addresses used, domains, URLs, data network traffic patterns, port activity information, network connections to known malicious hosts, data exfiltration patterns, and the like. Other types of IoCs may also include file based IoCs (such as malware and scripts), behavioral IoCs (such as unusual user behavior, login patterns, network traffic patterns, authentication attempts, etc.), metadata IoCs (such as metadata associated with files, documents, and the like, e.g., version information, authorship information, creation/modification timestamps, etc.), and host-based IoCs (such as activity of computing devices, filenames, hashes, registry keys, suspicious processes, etc.).

The sources of IoCs and risk feeds 320 may be varied. The sources may include security information and event management (SIEM) systems, cybersecurity event logs of third party computing systems, extended detection and response (XDR) systems, and other cybersecurity platforms of organizations. These sources of IoCs and risk feeds 320 may further include cybersecurity related publications from cybersecurity industry organizations, social media sources, cybersecurity news feeds, or any other source of reporting of cybersecurity information regarding security breaches and attacks on computing systems. The IoCs are public indicators of compromise which may include common vulnerabilities and exposure (CVE) records, known attack vectors, known ransom attacks, revocation registry, known day 1 exploits, known data leaks, and the like.

The IoCs and risk feeds from these sources 320 may be used as fine-tuning training data to fine-tune train the LM/LLM 302 for the particular purpose of recognizing patterns in inputs that could indicate a compromised credential and generating a risk assessment for a given input specifying characteristics of an interaction between entities of a decentralized identity framework. The fine-tuning builds upon the pretraining of the LM/LLM 302 by further directing the training to this particular task of risk assessment. This fine-tuning utilizes known or later developed transformer neural network architecture machine learning training techniques. As such fine-tuning training is generally known in the art, a more detailed explanation is not provided herein.

Thus, the LM/LLM 302 is trained to receive inputs comprising features descriptive of an interaction, and leverages the knowledge learned through the fine-tuning training of the LM/LLM 302 to generate assessments of risk for the interaction. The inputs may be provided in any suitable manner that conveys to the LM/LLM 302 the features of the interaction for processing by the LM/LLM 302. In some illustrative embodiments, the inputs may be provided as part of a prompt to the LM/LLM 302 which specifies the task to be performed, the tools that may be used by the LM/LLM 302 in performing the task, the context that is the basis for the performance of the task, and the type of response or output that the LM/LLM 302 is to generate. In some illustrative embodiments, this prompt may be a dynamic retrieval augmented generation (RAG) prompt. RAG is a GenAI architecture that augments a LM/LLM with dynamic trusted data retrieved from private knowledge bases or organization controlled sources associated with the entities of the decentralized identity framework. RAG prompts allow for the context of the prompt to specify a combination of public and private information as a basis for the LM/LLM 302 operation.

During runtime operation, the inputs to the LM/LLM 302 may be provided by decentralized identity event agents 332, 342, and/or 352 of the issuer 330, holder 340, and/or verifier 350. The decentralized identity event agents 332, 242, and 352 transmit information about a transaction or interaction between the corresponding entity 330, 340, and/or 350 in response to another entity initiating the transaction/interaction with it. Thus, for example, if a holder 340 attempts to perform a transaction with a verifier 350, the verifier 350 may collect the features of the transaction and transmit them to the LM/LLM 302 via its decentralized identity event agent 352 to thereby verify the credentials of the holder 340. Similarly, the holder 340 may transmit information about the transaction with a verifier 350 so as to verify the credentials of the verifier 350. The agents 332, 342, and 352 may transmit these transaction/interaction features as part of a dynamic RAG prompt to the LM/LLM 302.

The features included in the context in the dynamic RAG prompt generated and transmitted by the agent 332, 342, and 352 comprises the transaction/interaction features collected by the digital wallet, credential (identity) container, or other credential and transaction/interaction log data structures of the entity 330, 340, or 350 and thus, may be dependent upon which entity is submitting the dynamic RAG prompt. For example, as shown in FIG. 3, the issuer 330 may maintain in its digital wallet the credentials issued 335, the connections 336 created with other entities, e.g., holder 340, and credentials verified 337. The issuer 330 knows all the credentials that it has given out to holders, i.e., credentials issued 335, e.g., a state driver’s license office may issue a digital credential that contains information, such as name, address, height, weight, eye color, and an ID number. This is information that the issuer 330 would need to collect, such as from a digital passport or the like, and verify some of this information in order to issue the credential, i.e., the verified credentials 337. The connections are other holders and verifiers in a chain of interactions.

The act of issuance of a credential may also require some proofing process. When a holder, Bob, gets issued a digital credential, Bob has to prove it is Bob before the credential is issued to Bob. This is also part of the issuance process, and is additional metadata that can be used to assess the risk of a credential issuance process.

The verifier 350 may have a similar digital wallet that stores similar credentials issued 355, connections 356, and credentials verified 357. The holder 340 may maintain in their digital wallet the credentials 345 for that holder, the holder’s connections 346 with other entities, the proofs verified 347, and the credentials accepted 348. The proofs verified 347 is a history of all of the holder verifications, or every time the holder has presented its credentials for verification, e.g., if Bob, has to prove he is over 21, he gets a receipt that he had the proof of his age verified. Credentials accepted 348 is a list of credentials that have been issued that the holder has accepted, e.g., when Bob gets a driver’s license with his date of birth on it, he gets a receipt that he had accepted a credential in his digital wallet.

At each entity 330, 340, 350, the corresponding agent 332, 342, 352 may populate its corresponding dynamic RAG prompts with the digital wallet information maintained by the digital wallet for the particular transaction/interaction that is to have its risk evaluated. The digital wallet information in the RAG may also be combined with public information, such as may be obtained from the Web of Trust registry 360.

The dynamic RAG prompts from the decentralized identity event agents 332, 342, and/or 352 may be generated dynamically in response to the detection of an event involving an identity or credential, i.e., the initiation of a transaction or interaction between entities. Thus, for example, if the holder 340 attempts to log onto a computing system to access computing resources via the verifier 350, this event is detected by the decentralized identity event agent 352 of the verifier 350 and a corresponding dynamic RAG prompt is generated and transmitted to the LM/LLM 302. Similarly, if a verifier 350 requests information from the holder 340, this event may be detected by the agent 342 of the holder 340 and a corresponding dynamic RAG prompt sent to the LM/LLM 302 to thereby verify the verifier 350 to the holder 340.

The LM/LLM 302 receives the dynamic RAG prompt and processes the RAG prompt to generate a risk assessment output specifying an evaluation of the risks associated with the interaction/transaction. This risk assessment is then provided as input to the credential risk evaluator 312 which generates a quantitative score of the risk assessment and applies applicable risk and access policies based on the quantitative score. That is, the risk score computation engine 306 processes the output from the LM/LLM 302 to generate a numerical score indicating a level of risk of the transaction/interaction. The risk score computation engine 306 may utilize natural language processing to correlate particular terms indicative of levels of risk with particular numerical values along a risk range. The higher the score, the riskier the transaction/interaction, i.e., the more likely that the credentials involved are associated with a compromised entity in the decentralized identity framework.

Different risk policies and access policies may be associated with different instances of entities 330, 340, and 350 in the decentralized identity framework. That is, one instance of a holder 340 may have a first risk policy and access policy, while another instance of a holder 340 may have a second risk policy and second access policy. The same is true for various instances of issuers 330 and verifiers 350. The risk policy and access policy of a particular instance of an entity may be applied by the risk policy engine 308 and access policy engine 310. The risk policies specify the level of risk associated with a particular numerical score by the risk score computation engine 306. The access policies specify the operations to perform to grant or deny access to computing resources based on the determined level of risk generated by the risk policy engine 308 and the numerical score generated by the risk score computation engine 306. Thus, a level of risk and a type of access, if any, may be determined by the policy engines 308, 310.

Based on the application of the policies by the policy engines 308, 310, a response may be returned to the entity 330, 340, and/or 350 to inform them of the determined level of risk, the risk score, and the recommended access operation to be performed. The entity 330, 340, and 350 may then perform operations based on this determined level of risk, risk score, and recommended access operation, e.g., accept/reject the transaction/interaction with the other entity by accepting/rejecting the credentials of the other entity. In addition, this information may be presented through dashboards or other graphical user interfaces (GUIs) so as to inform administrators or other authorized personnel of the results of transactions/interactions with other entities of the decentralized identity framework. For example, in response to a determination that there is high risk of compromise, appropriate alerts and notifications may be presented to the involved entities to inform their authorized personnel of the high risk of compromise. Appropriate thresholds for risk scores may be predetermined to categorize risks into levels of risk, such as high, medium, and low risk of compromise, and corresponding actions, alerts, and notifications may be associated with each level of risk.

It should be appreciated that while FIG. 3 shows the GenAI based interaction risk assessor 300 as part of a third party computing system that operates as a server or service to entities of the distributed identity framework, in other illustrative embodiments, the GenAI based interaction risk assessor 300, or portions of the components 302-312, may be distributed to one or more of the entities themselves which may implement the distributed portions locally. For example, in some illustrative embodiments, the issuer 330, holder 340, and verifier 350 may each have their own instance of the credential risk evaluator 312 and its components rather than having the credential risk evaluator 312 being provided at the third party server as part of the risk assessor 300. In such embodiments, the entities 330-350 may implement their own corresponding instances 334, 344, and 354 of the credential risk evaluator 312 which operates in conjunction with a corresponding decentralized identity event agent 332, 342, and 352, respectively.

Thus, communication with the third party server is performed using the dynamic RAG prompts submitted by the agents 332, 342, and 352, the LM/LLM 302 processes these prompts and generates an output that is returned to the corresponding agent 332, 342, and 352. The LM/LLM 302 output is then processed locally at the entity 330, 340, 350 via its local instance of the credential risk evaluator 312 to thereby generate a risk score and apply appropriate risk and access policies that are specific to that entity 330, 340, and 350 based on its configuration of these policies. The entity 330, 340, and 350 may then perform appropriate actions and generate appropriate alerts/notifications based on its determined level of risk, risk score, and access operation recommendations.

Hence, the illustrative embodiments provide an improved computing tool and improved computing tool operations/functionality to provide automated GenAI based risk assessments of transactions and interactions between entities in decentralized identity frameworks. The mechanisms of the illustrative embodiments may operate to differentiate between identities that may be associated with compromises of entities of the framework, e.g., issuers, holders, or verifiers, and those that are not based on knowledge obtained from various IoC and risk feed sources and private information associated with the individual entities, e.g., from their digital wallets or credential containers.

It should be appreciated that in existing technology, there is no way for a holder, issuer, or verifier to know if a credential is compromised or potentially compromised. The illustrative embodiments provide a mechanism that balances the binary determination of “deny” or “approve” with regard to credentials by providing a specific risk assessment mechanism where the risk scoring is left to the verifiers or holders. For example, a driver’s license that has been revoked due to someone having a moving violation makes the driver’s license not valid to use to drive a motor vehicle. However, the same driver’s license can be used to get a library card at the local library. Due to this, the risk assessment of the credential needs to be considered with regard to different relationships and have different risk scores based on the different relationships. Thus, the risk assessments of the illustrative embodiments not only provide a metric for relative compromise, but also allow certain thresholds to be defined based on organization criticality that is driven based on the importance of risk in the interactions.

For example, an issuer 330 may issue a credential to a holder 340 and then, at a later date, that issuer 330 may become compromised by a bad actor. The holder 340 may then present the credential to a verifier 350. The verifier 350 may then automatically, through the mechanisms of the illustrative embodiments, such as decentralized identity event agent 352, generate a dynamic RAG populated with the verifier’s digital wallet/credential container contents, and obtain a LLM response indicating an assessment of risk of the interaction between the holder 340 and the verifier 350. The verifier’s credential risk evaluator 354 may then automatically score the risk and apply applicable risk and access policies to control permitting or denying operations based on the holder’s credential and the risks associated with the interaction/transaction. Appropriate alerts/notifications as specified in the policies may likewise be generated and/or transmitted, output on dashboards, or the like.

As another example, consider a scenario where the issuer 330 issues a credential to the holder 340 and then, the holder 340 initiates an operation that includes presentation of the holder’s credential to a verifier 350 which has been compromised. The holder 340 may automatically, through the mechanisms of the illustrative embodiments, such as decentralized identity event agent 342, and prior to presentation of its credentials to the verifier 350, generate a dynamic RAG populated with the holder’s digital wallet/credential container contents, and obtain a LLM response indicating an assessment of risk of the interaction between the holder 340 and the verifier 350. The holder’s credential risk evaluator 344 may then automatically score the risk and apply applicable risk and access policies to control permitting or denying operations based on the verifier’s information and the risks associated with the interaction/transaction. Appropriate alerts/notifications as specified in the policies may likewise be generated and/or transmitted, output on dashboards, or the like.

As another example, as part of issuing a credential, it is sometimes necessary to have to prove the provided data from the potential holder. This can be false data that the holder is providing based on things like exported and cloned credentials. By having a risk assessment mechanism of the illustrative embodiments check the data being provided for indicators of export or cloned credentials, the issuer may choose not to issue credentials to the holder. However, most of the time, it would be because issuers and verifiers are almost interchangeable, i.e., an issuer can also be a verifier and vice versa, and should have the same capabilities, e.g., the Department of Motor Vehicles is a verifier that an individual has particular utility bills at a given address before the Department of Motor Vehicles, as an issuer, issues a digital credential.

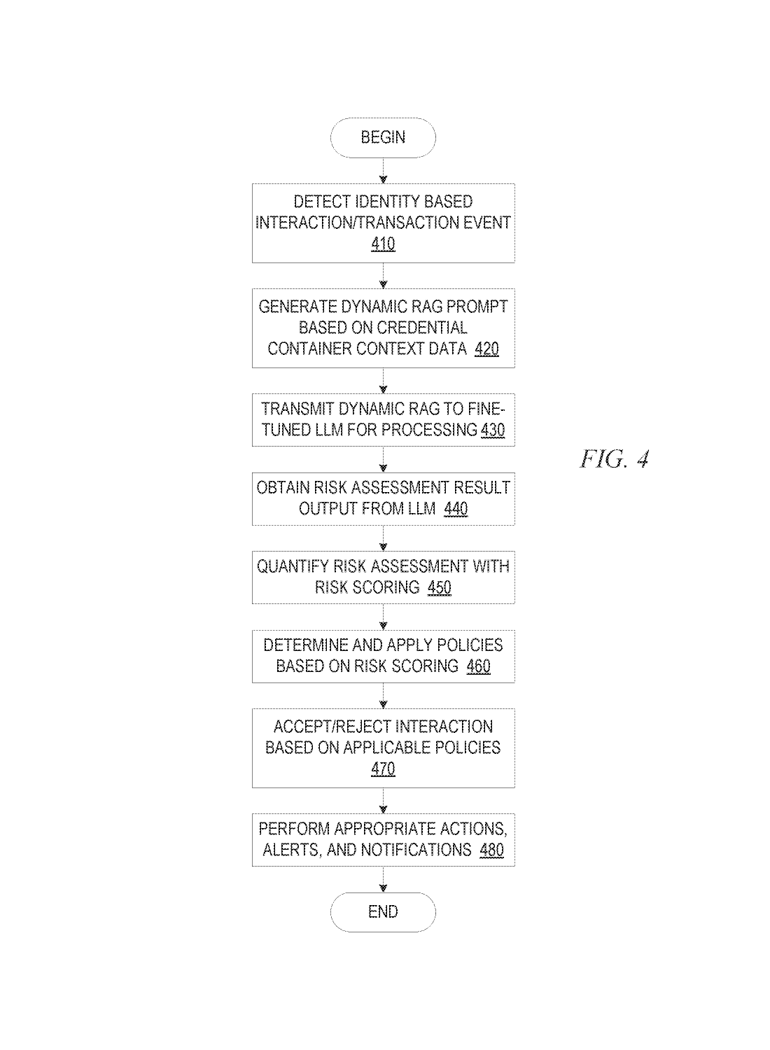

FIG. 4 is an example flowchart of a GenAI based interaction risk assessment operation in accordance with one illustrative embodiment. It should be appreciated that the operations outlined in FIG. 4 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIG. 4, and may, in some cases, make use of the results generated as a consequence of the operations set forth in FIG. 4, the operations in FIG. 4 themselves are specifically performed by the improved computing tool in an automated manner.

The operation outlined in FIG. 4 assumes that the LLM has been fine-tuned for risk assessments of transactions/interactions between entities of a decentralized identity framework. The operation is performed from the viewpoint of an entity of the decentralized identity framework and thus, a similar operation may be performed with regard to each entity based on its locally stored digital wallet/credential container information corresponding to the particular transaction/interaction being evaluated for risk of compromise.

As shown in FIG. 4, the operation starts by a decentralized identity event agent detecting an identity based interaction/transaction being initiated (step 410). The agent generates a dynamic RAG prompt comprising context information incorporating data corresponding to the interaction/transaction obtained from the local digital wallet/credential container of the entity (step 420). The dynamic RAG prompt is transmitted to a fine-tuned LLM (step 430) which processes the dynamic RAG prompt and returns a risk assessment result output (step 440). The risk of the interaction/transaction is quantified by a risk scoring engine based on the risk assessment result output from the LLM (step 450). The risk score generated is used as a basis for determining and applying a risk policy and an access policy to the interaction/transaction (step 460). Based on the applicable risk policy/access policies, the interaction/transaction is accepted/rejected (step 470) and appropriate actions, alerts, and notifications may be performed/generated (step 480). The operation then terminates.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
detecting, by a decentralized identity event agent executing in a first computing system of a decentralized identity framework, an identity based interaction between the first computing system and a second computing system of the decentralized identity framework;
automatically generating, by the decentralized identity event agent, a dynamic retrieval augmented generation (RAG) prompt comprising context information incorporating data corresponding to the interaction;
providing the dynamic RAG prompt to a language computer model for processing to generate a risk assessment output; and
applying one or more policies to the detected identity based interaction based on the risk assessment output to accept or reject performance of the identity based interaction between the first computing system and the second computing system.

2. The method of claim 1, further comprising generating a risk score based on the risk assessment output from the language computer model, wherein the one or more policies are applied to the detected identity based on the risk score.

3. The method of claim 1, wherein the language computer model is a pre-trained large language model (LLM) that is fine-tune trained to specifically perform risk assessments of identities based on input features from interactions of one or more verifier computing systems or digital identity containers of identity holder computing systems.

4. The method of claim 1, wherein the language computer model is a pre-trained large language model (LLM) that is fine-tune trained to specifically perform risk assessments of identities based on input features comprising indicators of compromise from third party computing systems.

5. The method of claim 4, wherein the third party computing systems comprise one or more of security information and event management (SIEM) computing systems, cybersecurity event logs of third party computing systems, or extended detection and response (XDR) computing systems.

6. The method of claim 1, wherein the first computing device is an identity holder computing device and the second computing device is an identity verifier computing device, and wherein the language computer model generates a risk assessment output that evaluates a level of risk of the holder computing device to the verifier computing device.

7. The method of claim 1, wherein the first computing device is an identity holder computing device and the second computing device is an identity verifier computing device, and wherein the language computer model generates a risk assessment output evaluates a level of risk of the verifier computing device to the holder computing device.

8. The method of claim 1, further comprising generating a graphical user interface on the first computing device specifying which verifiers and issuers in the decentralized identity framework have been determined to have a risk assessment indicating they are risky with which to perform interactions.

9. The method of claim 1, wherein the context information in the RAG prompt comprises interaction features collected by an identity container of an entity requesting verification of another entity involved in the identity based interaction.

10. The method of claim 1, wherein applying one or more policies to the detected identity comprises performing a remediation action to minimize risk to at least one of the first computing system or the second computing system.

11. The method of claim 1, wherein the context information in the RAG prompt comprises private features identifying specific features of the interaction, and public features obtained from a web of trust registry.

12. A computer program product comprising:
one or more computer-readable storage media; and
program instructions stored on the one or more computer-readable storage media to perform operations comprising:
detecting, by a decentralized identity event agent executing in a first computing system of a decentralized identity framework, an identity based interaction between the first computing system and a second computing system of the decentralized identity framework;
automatically generating, by the decentralized identity event agent, a dynamic retrieval augmented generation (RAG) prompt comprising context information incorporating data corresponding to the interaction;
providing the dynamic RAG prompt to a language computer model for processing to generate a risk assessment output; and
applying one or more policies to the detected identity based interaction based on the risk assessment output to accept or reject performance of the identity based interaction between the first computing system and the second computing system.

13. The computer program product of claim 12, wherein the operations further comprise generating a risk score based on the risk assessment output from the language computer model, wherein the one or more policies are applied to the detected identity based on the risk score.

14. The computer program product of claim 12, wherein the language computer model is a pre-trained large language model (LLM) that is fine-tune trained to specifically perform risk assessments of identities based on input features from interactions of one or more verifier computing systems or digital identity containers of identity holder computing systems.

15. The computer program product of claim 12, wherein the language computer model is a pre-trained large language model (LLM) that is fine-tune trained to specifically perform risk assessments of identities based on input features comprising indicators of compromise from third party computing systems.

16. The computer program product of claim 15, wherein the third party computing systems comprise one or more of security information and event management (SIEM) computing systems, cybersecurity event logs of third party computing systems, or extended detection and response (XDR) computing systems.

17. The computer program product of claim 12, wherein the first computing device is an identity holder computing device and the second computing device is an identity verifier computing device, and wherein the language computer model generates a risk assessment output that evaluates a level of risk of the holder computing device to the verifier computing device.

18. The computer program product of claim 12, wherein the first computing device is an identity holder computing device and the second computing device is an identity verifier computing device, and wherein the language computer model generates a risk assessment output evaluates a level of risk of the verifier computing device to the holder computing device.

19. The computer program product of claim 12, wherein the operations further comprise generating a graphical user interface on the first computing device specifying which verifiers and issuers in the decentralized identity framework have been determined to have a risk assessment indicating they are risky with which to perform interactions.

20. The computer program product of claim 12, wherein the context information in the RAG prompt comprises interaction features collected by an identity container of an entity requesting verification of another entity involved in the identity based interaction.

21. The computer program product of claim 12, wherein applying one or more policies to the detected identity comprises performing a remediation action to minimize risk to at least one of the first computing system or the second computing system.

22. The computer program product of claim 12, wherein the context information in the RAG prompt comprises private features identifying specific features of the interaction, and public features obtained from a web of trust registry.

23. A computer system comprising:
a processor set;
one or more computer-readable storage media; and
program instructions stored on the one or more computer-readable storage media to cause the processor set to perform operations comprising:
detecting, by a decentralized identity event agent executing in a first computing system of a decentralized identity framework, an identity based interaction between the first computing system and a second computing system of the decentralized identity framework;
automatically generating, by the decentralized identity event agent, a dynamic retrieval augmented generation (RAG) prompt comprising context information incorporating data corresponding to the interaction; and
providing the dynamic RAG prompt to a language computer model for processing to generate a risk assessment output; and
applying one or more policies to the detected identity based interaction based on the risk assessment output to accept or reject performance of the identity based interaction between the first computing system and the second computing system.

24. The computer system of claim 23, wherein the context information in the RAG prompt comprises interaction features collected by an identity container of an entity requesting verification of another entity involved in the identity based interaction.

25. The computer system of claim 23, wherein applying one or more policies to the detected identity comprises performing a remediation action to minimize risk to at least one of the first computing system or the second computing system.
